(19) United States
(12) Patent Application Publication
(10) Pub. No.: US 2025/0371663 A1
(43) Pub. Date: Dec. 4, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventor: KENJI TOKUTAKE, TOKYO (JP)

(21) Appl. No.: 18/870,735

(22) PCT Filed: Jun. 7, 2023
(86) PCT No.: PCT/JP2023/021117

§ 371 Date: Dec. 2, 2024

(30) Foreign Application Priority Data
Jun. 9, 2022 (JP) 2022-093680

(51) Int. Cl. G06T 3/4053; G06F 3/01

(52) U.S. Cl. CPC G06T 3/4053; G06F 3/013

(57) ABSTRACT

It is possible to achieve both a high-resolution real-space image used in, for example, a video see-through type of AR device or MR device, and reduced system load. By an image acquisition unit, a first image captured at a first angle of view and a second image captured at a second angle of view narrower than the first angle of view within the first angle of view are acquired. By an image generation unit, a display image is generated by synthesizing an image of a high-resolution region based on the second image and an image of a peripheral region around the high-resolution region based on the first image. For example, based on gaze information of a user, the movement of an imaging direction of an image capturing unit for obtaining the second image is controlled, and the movement of a position of the high-resolution region is also controlled.

### TECHNICAL FIELD

The present technology relates to an information processing device, an information processing method, and a program, and more particularly to an information processing device and the others suitable for use in obtaining real space images used in, for example, video see-through AR devices, MR devices, and the like.

### BACKGROUND ART

In recent years, the general adoption of virtual reality (VR) has accelerated reflecting low price virtual reality devices and enriched contents. Increasing the resolution to reproduce reality within a space is a very effective approach to improving the quality of user experience, and there is therefore a strong demand for reality with higher image quality than that for regular two-dimension (2D) content.

On the other hand, increasing the resolution of content and displaying displays increases the load on a processor such as a graphics processing unit (GPU) or a central processing unit (CPU) as well as the load on a system such as a memory or a bus. Therefore, in order to achieve both higher resolution and reduced system load, many representative virtual reality products adopt a foveated rendering technique, which renders a region of user's gaze in high definition and reduces the amount of rendering in the peripheral regions. For example, PTL 1 describes foveated rendering.

Virtual reality content has been generally focused on games and video viewing so far, but future virtual reality services will become more integrated with real society, and accordingly, new experiences and services of mixed reality (MR) with augmented reality (AR) experiences are expected to emerge as a space for social and economic activities. Such mixed reality is of a video see-through type that uses camera images.

### CITATION LIST

### Patent Literature

### PTL 1

JP 2020-042807A

### SUMMARY

### Technical Problem

An object of the present technology is to achieve both a high-resolution real-space image used in, for example, a video see-through type of AR device or MR device, and reduced system load.

### Solution to Problem

A concept of the present technology is

an information processing device including:
an image acquisition unit that acquires a first image captured at a first angle of view and a second image captured at a second angle of view narrower than the first angle of view within the first angle of view; and
an image generation unit that generates a display image by synthesizing an image of a high-resolution region based on the second image and an image of a peripheral region around the high-resolution region based on the first image.

In the present technology, by an image acquisition unit, a first image captured at a first angle of view and a second image captured at a second angle of view narrower than the first angle of view within the first angle of view are acquired. Then, by an image generation unit, a display image is generated by synthesizing an image of a high-resolution region based on the second image and an image of a peripheral region around the high-resolution region based on the first image.

For example, the image of the high-resolution region may be an image obtained by directly using the second image, and the image of the peripheral region may be an image obtained by upscaling the first image. In this case, for example, the first image and the second image may each have a first resolution, and the image of the peripheral region may be an image with a second resolution obtained by upscaling the first image according to a ratio between the first angle of view and the second angle of view. Here, the first resolution may be 1K resolution, and the second resolution may be 4K resolution.

For example, a wide-angle image capturing unit for obtaining the first image, and a magnified image capturing unit for obtaining the second image may be further included. For example, a display unit may be further included that displays a display image.

In this way, in the present technology, an image of a high-resolution region based on a first image captured at a first angle of view and an image of a peripheral region around the high-resolution region based on a second image captured at a second angle of view narrower than the first angle of view within the first angle of view are synthesized to generate a display image, which makes it possible to achieve both a high-resolution real-space image used in, for example, a video see-through type of AR device or MR device, and reduced system load.

In the present technology, for example, a control unit may be further included that, based on gaze information of a user, controls movement of an imaging direction of an image capturing unit for obtaining the second image and controls movement of a position of the high-resolution region. This makes it possible to position the high-resolution region including the high-resolution image by following the user's gaze. In this case, for example, a gaze detection unit may be further included that detects the gaze information of the user.

In the present technology, for example, a control unit may be further included that controls switching of an image capturing unit for obtaining the second image based on information on a distance to a subject related to the second image. This makes it possible to provide, as the image of the high-resolution region, a high-quality image with reduced blurring and the like, regardless of the distance to the subject.

In this case, for example, the control unit may be configured to switch the image capturing unit for obtaining the second image to either a first image capturing unit for a first imaging distance or a second image capturing unit for an imaging distance longer or shorter than the first imaging distance. Here, for example, the first image capturing unit may be a normal image capturing unit, and the second image capturing unit may be a telephoto image capturing unit or a close-up image capturing unit.

In this case, for example, the control unit may be configured to switch the image capturing unit for obtaining the second image to any one of a first image capturing unit for a first imaging distance, a second image capturing unit for an imaging distance longer than the first imaging distance, and a third image capturing unit for an imaging distance shorter than the first imaging distance. Here, for example, the first image capturing unit may be a normal image capturing unit, the second image capturing unit may be a telephoto image capturing unit, and the third image capturing unit may be a close-up image capturing unit.

Additionally, another concept of the present technology is an information processing method including the steps of:

acquiring a first image captured at a first angle of view and a second image captured at a second angle of view narrower than the first angle of view within the first angle of view; and
generating a display image by synthesizing an image of a high-resolution region based on the second image and an image of a peripheral region around the high-resolution region based on the first image.

Additionally, another concept of the present technology is a program for causing a computer to execute an information processing method including the steps of:

acquiring a first image captured at a first angle of view and a second image captured at a second angle of view narrower than the first angle of view within the first angle of view; and generating a display image by synthesizing an image of a high-resolution region based on the second image and an image of a peripheral region around the high-resolution region based on the first image.

### BRIEF DESCRIPTION OF DRAWINGS

FIG. 1 is a diagram illustrating an example of a conventional VR display system.

FIG. 2 is a diagram illustrating an example of a conventional AR/MR display system.

FIG. 3 is a diagram illustrating a configuration example of a display system for a real space image, as an embodiment.

FIG. 4 is a diagram illustrating another configuration example of a display system for a real space image, as an embodiment.

FIG. 5 is a diagram illustrating another configuration example of a display system for a real space image, as an embodiment.

FIG. 6 is a diagram illustrating another configuration example of a display system for a real space image, as an embodiment.

FIG. 7 is a diagram illustrating another configuration example of a display system for a real space image, as an embodiment.

FIG. 8 is a configuration diagram illustrating an example of data transfer in a display system.

FIG. 9 is a diagram illustrating a configuration example (functional configuration example) of an information processing device corresponding to the display system.

FIG. 10 is a flowchart illustrating an example of a processing procedure of the information processing device.

### DESCRIPTION OF EMBODIMENTS

Modes for carrying out the present invention (hereinafter referred to as “embodiments”) will be described below. The description will be made in the following order.
1. Embodiment
2. Modification Example

### 1. Embodiment

VR Display System, AR/MR Display system

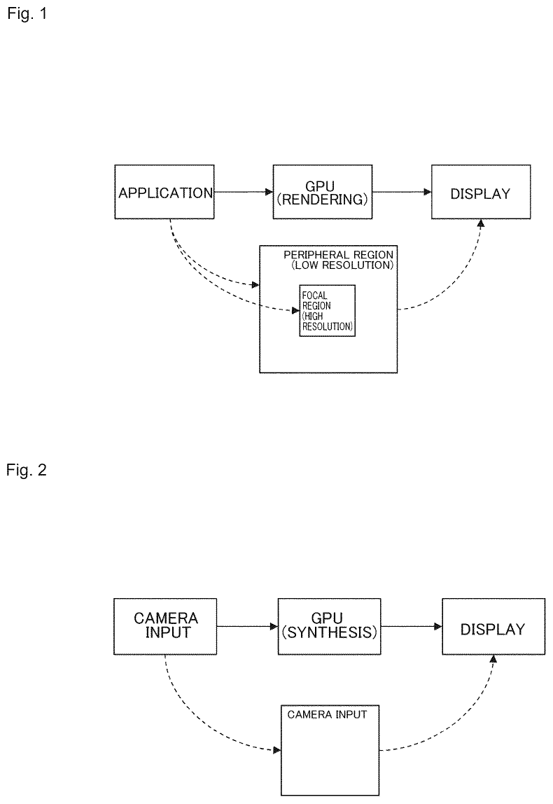

FIG. 1 illustrates an example of a conventional VR display system. Drawing data is transmitted through a graphics application programming interface (API) from an application, for example, a game application, to a graphics processing unit (GPU), where rendering is performed on the basis of the drawing data to generate a display image.

In this case, for example, in order to achieve both high-resolution and reduced system load, foveated rendering is performed in which a focal region (high-resolution region) including a point of gaze (viewpoint) of a user and a peripheral region (low-resolution region) around the focal region are set and the display image is rendered. The display image generated by this foveated rendering is displayed on a display.

FIG. 2 illustrates an example of a conventional AR/MR display system. A camera input as a real-space image is transmitted to a GPU, where synthesis processing is performed in which a user interface (UI) image and a computer graphics (CG) image are superimposed onto a real-space image to generate a display image. This display image is displayed on a display.

In this case, the camera input is directly used as the real-space image in the GPU synthesis processing. This makes it difficult to achieve both a high-resolution real-space image and reduced system load. For example, in the case of a 4K resolution video see-through type of AR device or MR device, two RGB cameras (RGB 60 Hz×4K×2), two simultaneous localization and mapping (SLAM) cameras, and two displays are operated simultaneously, which increases the system load.

### First Configuration Example of Display System

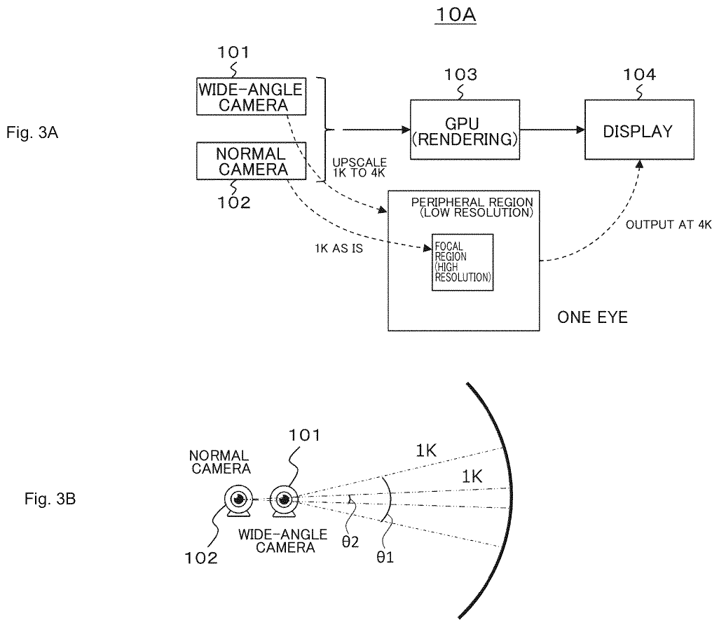

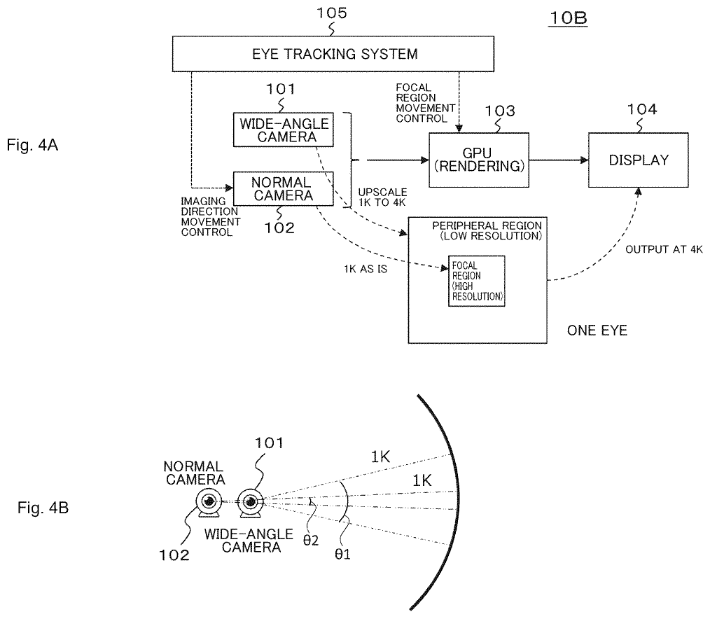

In FIG. 3, (a) illustrates a configuration example of a display system 10A for a real space image, which is installed in a head-mounted display and is used in a video see-through type of AR device, MR device, or the like, as an embodiment. The configuration example illustrated here is of only portions for one eye. This display system 10A includes a wide-angle camera 101, a normal camera 102, a GPU 103, and a display 104.

The wide-angle camera 101 constitutes a wide-angle image capturing unit, and has a wide angle of view and can capture a wide range image. The normal camera 102 constitutes a normal image capturing unit, and has a narrow angle of view but can capture a narrow range image at high resolution. Since this normal camera 102 can capture a narrow range image at high resolution, it also constitutes a magnifying camera. As illustrated in (b) of FIG. 3, the wide-angle camera 101 captures an image at an angle of view θ1 and outputs the image with a resolution of 1K (1080×1080), and the normal camera 102 captures an image at an angle of view θ2 corresponding to ¼ of the imaging range of the wide-angle camera 101 and outputs the image with a resolution of 1K (1080×1080).

The GPU 103 synthesizes an image of the focal region (high-resolution region) based on the image captured by the normal camera 102 and an image of the peripheral region (low-resolution region) around the focal region based on the image captured by the wide-angle camera 101, that is, performs foveated rendering, to generate a 4K resolution display image.

In this case, as the image of the focal region (high-resolution region), the 1K resolution image captured by the normal camera 102 is directly used. As the image of the peripheral region, a 4K resolution image is used here, obtained by upscaling the 1K resolution image captured by the wide-angle camera 101 by a factor according to the ratio between the angle of view θ1 and the angle of view θ2, that is, the ratio of the imaging ranges of the wide-angle camera 101 and the normal camera 102, that is, by a factor of 4.

In this case, the position of the focal region (high-resolution region) in the 4K resolution display image is set to a position corresponding to the position of the imaging range of the normal camera 102 within the imaging range of the wide-angle camera 101, and is set to the central position here.

To synthesize the image of the focal region (high-resolution region) and the image of the peripheral region (low-resolution region) to generate a 4K resolution display image, the GPU 103 further performs correction processing on a joint portion between the two regions to smooth the joint. This makes it possible to reduce the sense of discomfort felt by the user at the joint portion.

The display 104 displays the 4K resolution display image generated by the GPU 103.

In the display system 10A illustrated in (a) of FIG. 3, to generate a 4K resolution display image, a 1K resolution image of a narrow range captured at high resolution with the normal camera 102 is directly used as the image of the focal region (high-resolution region), and a 4K resolution image obtained by upscaling a 1K resolution image of a wide range captured with the wide-angle camera 101 is used as the image of the peripheral region (low-resolution region). It is possible to achieve both a high-resolution real space image and reduced system load without capturing a camera input at 4K resolution.

In the display system 10A illustrated in (a) of FIG. 3, an example is presented in which the wide-angle camera 101 outputs a 1K resolution image, as with the normal camera 102. However, the wide-angle camera 101 may also output an image with a resolution higher than 1K resolution. For example, if the wide-angle camera 101 is for outputting a 2K resolution image, the image is upscaled to obtain a 4K resolution image, which is used as the image of the peripheral region.

### Second Configuration Example of Display System

In FIG. 4, (a) illustrates a configuration example of a display system 10B for a real space image, which is installed in a head-mounted display and is used in a video see-through type of AR device, MR device, or the like, as an embodiment. The configuration example illustrated here is of only portions for one eye. In (a) of FIG. 4, the same reference numerals are used for the portions corresponding to those in (a) of FIG. 3, and detailed descriptions thereof will be omitted as appropriate. In FIG. 4, (b) is the same diagram as (b) of FIG. 3.

This display system 10B includes a wide-angle camera 101, a normal camera 102, a GPU 103, a display 104, and an eye tracking system 105.

The eye tracking system 105 analyzes in real time a face image of a user (person) captured by, for example, an infrared camera to acquire gaze information. On the basis of the gaze information, the eye tracking system 105 then controls the movement of the imaging direction of the normal camera 102 so that the imaging direction matches the gaze. On the basis of the gaze information, the eye tracking system 105 also controls the movement of the focal region (high-resolution region) so that the focal region matches the gaze.

The other portions of the display system 10B illustrated in (a) of FIG. 4 are configured, as with the display system 10A illustrated in (a) of FIG. 3.

In the display system 10B illustrated in (a) of FIG. 4, it is possible to achieve both a high-resolution real space image and reduced system load without capturing a camera input at 4K resolution, as with the display system 10A illustrated in (a) of FIG. 3.

In the display system 10B illustrated in (a) of FIG. 4, the movement of the imaging direction of the normal camera 102 is controlled to match the user's gaze, and the movement of the focal region (high-resolution region) within the 4K resolution display image is also controlled, allowing the user to always view the real-space image in the gaze direction in high resolution.

### Third Configuration Example of Display System

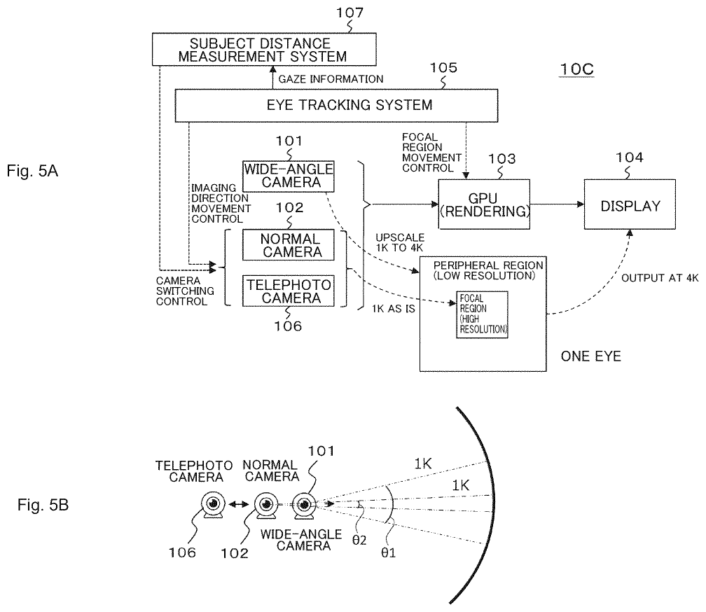

In FIG. 5, (a) illustrates a configuration example of a display system 10C for a real space image, which is installed in a head-mounted display and is used in a video see-through type of AR device, MR device, or the like, as an embodiment. The configuration example illustrated here is of only portions for one eye. In (a) of FIG. 5, the same reference numerals are used for the portions corresponding to those in (a) of FIG. 4, and detailed descriptions thereof will be omitted as appropriate.

This display system 10C includes a wide-angle camera 101, a normal camera 102, a GPU 103, a display 104, an eye tracking system 105, a telephoto camera 106, and a subject distance measurement system 107.

The telephoto camera 106 constitutes a telephoto image capturing unit, and has a narrow angle of view but can capture a narrow range at high resolution, as with the normal camera 102. Since the telephoto camera 106 can capture a narrow range at high resolution, it also constitutes a magnifying camera, as with the normal camera 102. As illustrated in (b) of FIG. 5, the telephoto camera 106 captures an image at an angle of view θ2 corresponding to ¼ of the imaging range of the wide-angle camera 101 and outputs the image with a resolution of 1K (1080×1080), as with the normal camera 102.

In this display system 10C, the normal camera 102 or the telephoto camera 106 is selectively used as the magnifying camera. Here, the normal camera 102 is adapted for an imaging distance of, for example, 10 cm or more and less than 10 m, and the telephoto camera 106 is adapted for an imaging distance of, for example, 10 m or more.

The subject distance measurement system 107 acquires information on a distance to a subject in the gaze direction using, for example, a SLAM camera. The acquisition of this distance information is not limited to using a SLAM camera, and may be performed using other methods.

The subject distance measurement system 107 dynamically switches the camera to be used as the magnifying camera to the normal camera 102 or the telephoto camera 106 according to the distance to the subject in the gaze direction of the user. In this case, for example, when the distance to the subject in the gaze direction is less than 10 m, the camera is switched to the normal camera 102, and when the distance to the subject in the gaze direction is 10 m or more, the camera is switched to the telephoto camera 106.

The eye tracking system 105 analyzes in real time a face image of the user (person) captured by, for example, an infrared camera to acquire gaze information. On the basis of the gaze information, the eye tracking system 105 then controls the movement of the imaging direction of the magnifying camera (the normal camera 102, the telephoto camera 106) so that the imaging direction matches the gaze. On the basis of the gaze information, the eye tracking system 105 also controls the movement of the focal region (high-resolution region) so that the focal region matches the gaze.

The other portions of the display system 10C illustrated in (a) of FIG. 5 are configured, as with the display system 10B illustrated in (a) of FIG. 4.

In the display system 10C illustrated in (a) of FIG. 5, it is possible to achieve both a high-resolution real space image and reduced system load without capturing a camera input at 4K resolution, as with the display system 10A illustrated in (a) of FIG. 3.

In the display system 10C illustrated in (a) of FIG. 5, the movement of the imaging direction of the magnifying camera (the normal camera 102, the telephoto camera 106) is controlled to match the user's gaze, and the movement of the focal region (high-resolution region) within the 4K resolution display image is also controlled, allowing the user to always view the real-space image in the gaze direction in high resolution, as with the display system 10B illustrated in (a) of FIG. 4.

In the display system 10C illustrated in (a) of FIG. 5, the camera to be used as the magnifying camera can be dynamically switched to the normal camera 102 or the telephoto camera 106 according to the distance to the subject in the gaze direction of the user, allowing the user to always view the real space image in the gaze direction in an appropriate state, for example, in a more focused state.

### Fourth Configuration Example of Display System

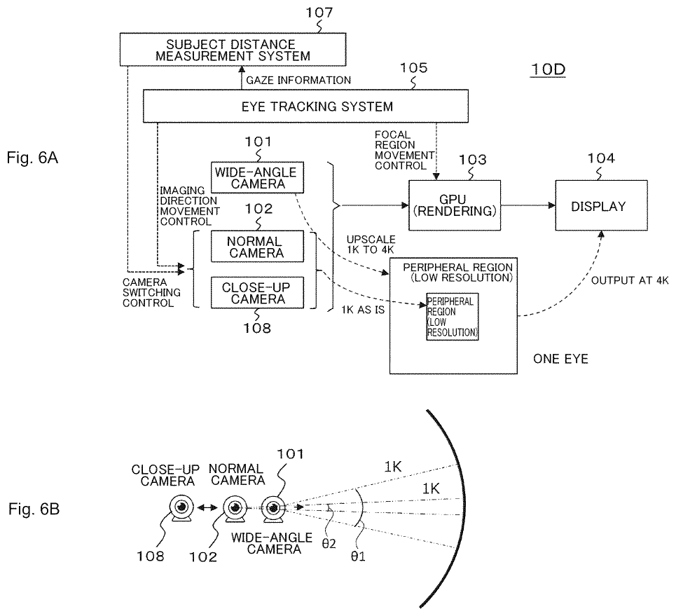

In FIG. 6, (a) illustrates a configuration example of a display system 10D for a real space image, which is installed in a head-mounted display and is used in a video see-through type of AR device, MR device, or the like, as an embodiment. The configuration example illustrated here is of only portions for one eye. In (a) of FIG. 6, the same reference numerals are used for the portions corresponding to those in (a) of FIG. 5, and detailed descriptions thereof will be omitted as appropriate.

The display system 10D includes a wide-angle camera 101, a normal camera 102, a GPU 103, a display 104, an eye tracking system 105, a subject distance measurement system 107, and a close-up camera (macro camera) 108.

The close-up camera 108 constitutes a close-up image capturing unit, and has a narrow angle of view but can capture a narrow range at high resolution, as with the normal camera 102. Since the close-up camera 108 can capture a narrow range at high resolution, it also constitutes a magnifying camera, as with the normal camera 102. As illustrated in (b) of FIG. 6, the close-up camera 108 captures an image at an angle of view θ2 corresponding to ¼ of the imaging range of the wide-angle camera 101 and outputs the image with a resolution of 1K (1080×1080), as with the normal camera 102.

In this display system 10D, the normal camera 102 or the close-up camera 108 is selectively used as the magnifying camera. Here, the normal camera 102 is adapted for an imaging distance of, for example, 10 cm or more and less than 10 cm, and the close-up camera 108 is adapted for an imaging distance of, for example, less than 10 m.

The subject distance measurement system 107 acquires information on a distance to a subject in the gaze direction using, for example, a SLAM camera. The acquisition of this distance information is not limited to using a SLAM camera, and may be performed using other methods.

The subject distance measurement system 107 dynamically switches the camera to be used as the magnifying camera to the normal camera 102 or the close-up camera 108 according to the distance to the subject in the gaze direction of the user. In this case, for example, when the distance to the subject in the gaze direction is 10 cm or more, the camera is switched to the normal camera 102, and when the distance to the subject in the gaze direction is less than 10 cm, the camera is switched to the close-up camera 108.

The eye tracking system 105 analyzes in real time a face image of the user (person) captured by, for example, an infrared camera to acquire gaze information. On the basis of the gaze information, the eye tracking system 105 then controls the movement of the imaging direction of the magnifying camera (the normal camera 102, the close-up camera 108) so that the imaging direction matches the gaze. On the basis of the gaze information, the eye tracking system 105 also controls the movement of the focal region (high-resolution region) so that the focal region matches the gaze.

The other portions of the display system 10D illustrated in (a) of FIG. 6 are configured, as with the display system 10C illustrated in (a) of FIG. 5.

In the display system 10D illustrated in (a) of FIG. 6, it is possible to achieve both a high-resolution real space image and reduced system load without capturing a camera input at 4K resolution, as with the display system 10A illustrated in (a) of FIG. 3.

In the display system 10D illustrated in (a) of FIG. 6, the movement of the imaging direction of the magnifying camera (the normal camera 102, the close-up camera 108) is controlled to match the user's gaze, and the movement of the focal region (high-resolution region) within the 4K resolution display image is also controlled, allowing the user to always view the real-space image in the gaze direction in high resolution, as with the display system 10B illustrated in (a) of FIG. 4.

In the display system 10D illustrated in (a) of FIG. 6, the camera to be used as the magnifying camera can be dynamically switched to the normal camera 102 or the close-up camera 108 according to the distance to the subject in the gaze direction of the user, allowing the user to always view the real space image in the gaze direction in an appropriate state, for example, in a more focused state.

### Fifth Configuration Example of Display System

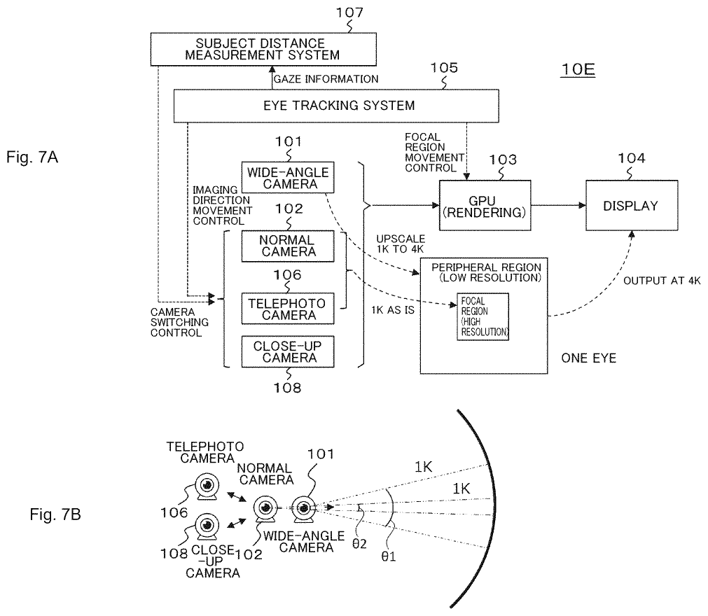

In FIG. 7, (a) illustrates a configuration example of a display system 10E for a real space image, which is installed in a head-mounted display and is used in a video see-through type of AR device, MR device, or the like, as an embodiment. The configuration example illustrated here is of only portions for one eye. In (a) of FIG. 7, the same reference numerals are used for the portions corresponding to those in (a) of FIG. 5 and (a) of FIG. 6, and detailed descriptions thereof will be omitted as appropriate.

The display system 10E includes a wide-angle camera 101, a normal camera 102, a GPU 103, a display 104, an eye tracking system 105, a telephoto camera 106, a subject distance measurement system 107, and a close-up camera (macro camera) 108.

The telephoto camera 106 constitutes a telephoto image capturing unit, and has a narrow angle of view but can capture a narrow range at high resolution, as with the normal camera 102. The close-up camera 108 constitutes a close-up image capturing unit, and has a narrow angle of view but can capture a narrow range at high resolution, as with the normal camera 102.

Since the telephoto camera 106 and the close-up camera 108 can each capture a narrow range at high resolution, it also constitutes a magnifying camera, as with the normal camera 102. As illustrated in (b) of FIG. 7, the telephoto camera 106 and the close-up camera 108 each capture an image at an angle of view θ2 corresponding to ¼ of the imaging range of the wide-angle camera 101 and outputs the image with a resolution of 1K (1080×1080), as with the normal camera 102.

In this display system 10E, the normal camera 102, the telephoto camera 106, or the close-up camera 108 is selectively used as the magnifying camera. Here, the normal camera 102 is adapted for an imaging distance of, for example, 10 cm or more and less than 10 m, the telephoto camera 106 is adapted for an imaging distance of, for example, 10 m or more, and the close-up camera 108 is adapted for an imaging distance of, for example, less than 10 cm.

The subject distance measurement system 107 acquires information on a distance to a subject in the gaze direction using, for example, a SLAM camera. The acquisition of this distance information is not limited to using a SLAM camera, and may be performed using other methods.

The subject distance measurement system 107 dynamically switches the camera to be used as the magnifying camera to the normal camera 102, the telephoto camera 106, or the close-up camera 108 according to the distance to the subject in the gaze direction of the user. In this case, for example, when the distance to the subject in the gaze direction is 10 cm or more and less than 10 m, the camera is switched to the normal camera 102; when the distance of the subject in the gaze direction is 10 m or more, the camera is switched to the telephoto camera 106; and when the distance of the subject in the gaze direction is less than 10 cm, the camera is switched to the close-up camera 108.

The eye tracking system 105 analyzes in real time a face image of the user (person) captured by, for example, an infrared camera, to acquire gaze information. On the basis of the gaze information, the eye tracking system 105 then controls the movement of the imaging direction of the magnifying camera (the normal camera 102, the telephoto camera 106, the close-up camera 108) so that the imaging direction matches the gaze. On the basis of the gaze information, the eye tracking system 105 also controls the movement of the focal region (high-resolution region) so that the focal region matches the gaze.

The other portions of the display system 10E illustrated in (a) of FIG. 7 are configured, as with the display system 10C illustrated in (a) of FIG. 5 and the display system 10D illustrated in (a) of FIG. 6.

In the display system 10E illustrated in (a) of FIG. 7, it is possible to achieve both a high-resolution real space image and reduced system load without capturing a camera input at 4K resolution, as with the display system 10A illustrated in (a) of FIG. 3.

In the display system 10E illustrated in (a) of FIG. 7, the movement of the imaging direction of the magnifying camera (the normal camera 102, the telephoto camera 106, the close-up camera 108) is controlled to match the user's gaze, and the movement of the focal region (high-resolution region) within the 4K resolution display image is also controlled, allowing the user to always view the real-space image in the gaze direction in high resolution, as with the display system 10B illustrated in (a) of FIG. 4.

In the display system 10E illustrated in (a) of FIG. 7, the camera to be used as the magnifying camera can be dynamically switched to the normal camera 102, the telephoto camera 106, or the close-up camera 108 according to the distance to the subject in the gaze direction of the user, allowing the user to always view the real space image in the gaze direction in an appropriate state, for example, in a more focused state.

### Configuration Diagram of Data Transfer on Display System

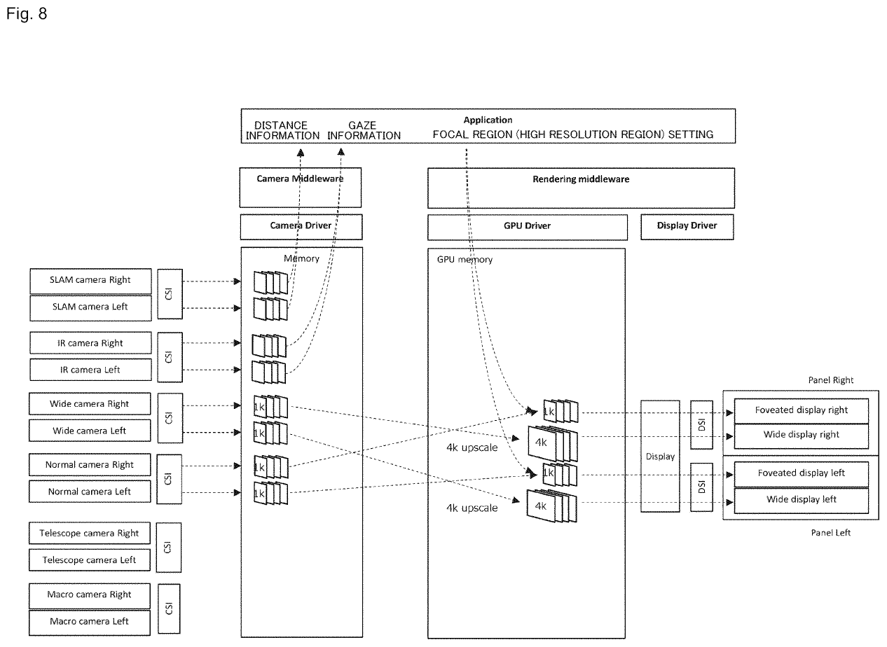

FIG. 8 is a configuration diagram illustrating an example of data transfer in the display system 10E illustrated in FIG. 7.

“SLAM camera Right” refers to a SLAM camera on the right side for acquiring information on a distance to a subject in the gaze direction, and “SLAM camera Left” refers to a SLAM camera on the left side for acquiring information on a distance to a subject in the gaze direction. “IR camera Right” refers to an infrared (IR) camera on the right side for acquiring gaze information of the user, and “IR camera Left” refers to an IR camera on the left side for acquiring gaze information of the user.

“Wide camera Right” refers to a wide-angle camera on the right side, and “Wide camera Left” refers to a wide-angle camera on the left side. “Normal camera Right” refers to a normal camera on the right side, and “Normal camera Left” refers to a normal camera on the left side. “Telescope camera Right” refers to a telephoto camera on the right side, and “Telescope camera Left” refers to a telephoto camera on the left side. “Macro camera Right” refers to a close-up camera (macro camera) on the right side, and “Macro camera Left” refers to a close-up camera (macro camera) on the left side.

“Memory” refers to a memory that temporarily stores output data of each camera. In this case, the output data from each camera is transferred to “Memory” via “CSI”, that is, a camera serial interface.

“Camera Driver” refers to a driver that controls each camera. “Camera Middleware” imports output data from the IR camera, and analyzes the face image to acquire gaze information. “Camera Middleware” also imports and processes output data from the SLAM camera to acquire the information on the distance to the subject in the gaze direction.

“Application” controls, based on the gaze information acquired by “Camera Middleware”, the movement of the imaging direction of the magnifying camera (normal camera, telephoto camera, close-up camera) so that the imaging direction matches the gaze. “Application” also dynamically switches, based on the information on the distance to the subject in the gaze direction acquired by “Camera Middleware”, the camera to be used as the magnifying camera to the normal camera, the telephoto camera, or the close-up camera.

“Application” also sets, based on the gaze information acquired by “Camera Middleware”, the position of the focal region (high-resolution region) so that it matches the gaze. “Rendering middleware” refers to a module that performs synthesis, rendering processing, and display processing. “GPU Driver” refers to a GPU control driver. “GPU memory” refers to a memory used by “Rendering middleware” to perform synthesis and rendering processing to generate a display image.

In this synthesis and rendering processing, to generate a 4K resolution display image, a 1K resolution image of a narrow range captured at high resolution with the magnifying camera is directly used as the image of the focal region (high-resolution region), and a 4K resolution image obtained by upscaling a 1K resolution image of a wide range captured with the wide-angle camera is used as the image of the peripheral region (low-resolution region).At this time, the position of the focal region (high-resolution region) is set to the position set by “Application” based on the gaze information.

“Display Driver” configures a display panel. “Display” refers to a hardware module that transfers the display image in “GPU memory” to panels. “Panel Right” refers to a display panel on the right side, and “Panel Left” refers to a display panel on the left side. A display image for the right side generated by the GPU performing the synthesis and rendering processing is transferred from “GPU memory” via “Display” and then via “DSI”, that is, a display serial interface, to “Panel Right”, where the display image is displayed. Similarly, a display image for the left side generated by the GPU performing the synthesis and rendering processing is transferred from “GPU memory” via “Display” and then via “DSI”, that is, a display serial interface, to “Panel Left”, where the display image is displayed.

### Configuration Example of Information Processing Device

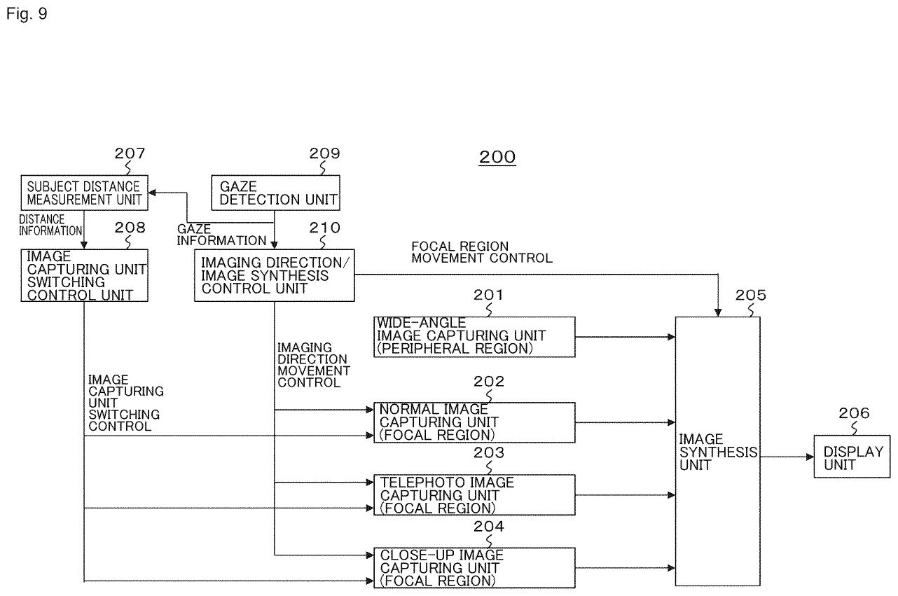

FIG. 9 illustrates a configuration example (functional configuration example) of an information processing device 200 corresponding to the display system 10E illustrated in (a) of FIG. 7. The information processing device 200 includes a wide-angle image capturing unit 201, a normal image capturing unit 202, a telephoto image capturing unit 203, a close-up image capturing unit 204, an image synthesis unit 205, a display unit 206, a subject distance measurement unit 207, an image capturing unit switching control unit 208, a gaze detection unit 209, and an imaging direction/image synthesis control unit 210.

The wide-angle image capturing unit 201 corresponds to the wide-angle camera 101, the normal image capturing unit 202 corresponds to the normal camera 102, the telephoto image capturing unit 203 corresponds to the telephoto camera 106, and the close-up image capturing unit 204 corresponds to the close-up camera 108. The normal image capturing unit 202, the telephoto image capturing unit 203, and the close-up image capturing unit 204 constitute a magnified image capturing unit.

The gaze detection unit 209 and the imaging direction/image synthesis control unit 210 correspond to the eye tracking system 105. The subject distance measurement unit 207 and the image capturing unit switching control unit 208 correspond to the subject distance measurement system 107.

The gaze detection unit 209 analyzes in real time a face image of a user (person) captured by, for example, an infrared camera, to acquire gaze information. The subject distance measurement unit 207 acquires information on a distance to the subject in the gaze direction of the user based on, for example, output data from a SLAM camera and further gaze information acquired by the gaze detection unit 209.

The image capturing unit switching control unit 208 dynamically switches the image capturing unit to be used as the magnified image capturing unit to the normal image capturing unit 202, the telephoto image capturing unit 203, or the close-up image capturing unit 204 according to the distance to the subject in the gaze direction of the user acquired by the subject distance measurement unit 207.

The imaging direction/image synthesis control unit 210 controls, based on the gaze information acquired by the gaze detection unit 209, the movement of the imaging direction of the magnified image capturing unit (the normal image capturing unit 202, the telephoto image capturing unit 203, the close-up image capturing unit 204) so that the imaging direction matches the gaze.

The image synthesis unit 205 corresponds to the GPU 103. The image generation unit 205 synthesizes an image of the focal region (high-resolution region) based on the image captured by the magnified image capturing unit (the normal image capturing unit 202, the telephoto image capturing unit 203, the close-up image capturing unit 204) and an image of the peripheral region (low-resolution region) around the focal region based on the image captured by the wide-angle image capturing unit 201, that is, performs foveated rendering, to generate a 4K resolution display image.

Here, as the image of the focal region (high-resolution region), the 1K resolution image captured by the magnified image capturing unit (the normal image capturing unit 202, the telephoto image capturing unit 203, the close-up image capturing unit 204) is directly used. As the image of the peripheral region, a 4K resolution image is used, obtained by upscaling the 1K resolution image captured by the wide-angle image capturing unit 201 by a factor of 4.

In this case, the imaging direction/image synthesis control unit 210 controls, based on the gaze information acquired by the gaze detection unit 209, the movement of the position of the focal region (high-resolution region) so that the position matches the gaze.

The display unit 206 corresponds to the display 104. The display unit 206 displays the display image generated by the image synthesis unit 205.

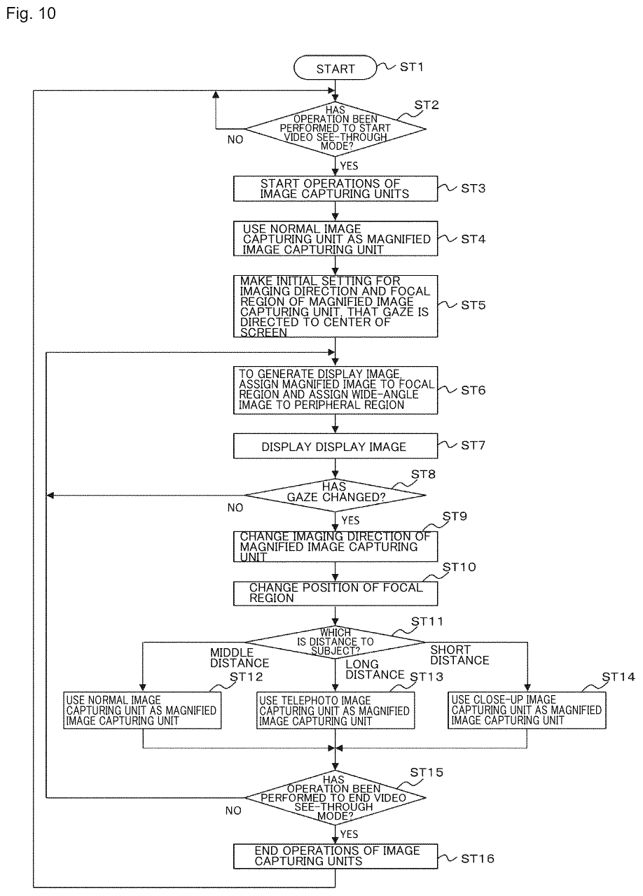

A flowchart of FIG. 10 illustrates an example of a processing procedure of the information processing device 200 illustrated in FIG. 9. First, in step ST1, the information processing device 200 starts processing. Next, in step ST2, the information processing device 200 determines whether the user has performed an operation to start a video see-through mode. When the user has performed an operation to start the video see-through mode, the information processing device 200 starts, in step ST3, the operations of the image capturing units (the wide-angle image capturing unit 201, the normal image capturing unit 202, the telephoto image capturing unit 203, and the close-up image capturing unit 204).

Next, in step ST4, the information processing device 200 sets, by the image capturing unit switching control unit 208, the normal image capturing unit 202 to be used as the magnified image capturing unit. Next, in step ST5, the information processing device 200 makes, by the imaging direction/image synthesis unit 210, initial setting for the imaging direction and focal region (high-resolution region) of the magnified image capturing unit, that the user's gaze is directed to the center of a screen.

Next, in step ST6, to generate a 4K resolution display image, the information processing device 200, by the image synthesis unit 205, assigns the magnified image (the 1K resolution image captured by the magnified image capturing unit) to the focal region (high-resolution region), and upscales the wide-angle image (the 1K resolution image captured by the wide-angle image capturing unit 201) by a factor of 4, and assigns the resulting image to the peripheral region. Next, in step ST7, the information processing device 200 displays the display image as a real space image on the display unit 206.

Next, in step ST8, the information processing device 200 determines whether the user's gaze acquired by the gaze detection unit 209 has changed. In determining whether the gaze has changed, when the gaze has changed by a preset threshold value or more, the gaze may be determined to have changed. This makes it possible to reduce the frequency of changing the imaging direction and focal region (high-resolution region) of the magnified image capturing unit, thereby reducing the processing load. When the user's gaze has not changed, the information processing device 200 returns to the processing of step ST6 to repeat the same processing as described above.

On the other hand, when the user's gaze has changed, then in step ST9, the information processing device 200 controls (changes), by the imaging direction/image synthesis unit 210, the movement of the imaging direction of the magnified image capturing unit so that the imaging direction matches the gaze. Next, in step ST10, the information processing device 200 controls (changes), by the imaging direction/image synthesis unit 210, the position of the focal region (high-resolution region) so that it matches the gaze. After the processing of step ST10, the information processing device 200 proceeds to the processing of step ST11.

In step ST11, the information processing device 200 determines whether the distance to the subject in the gaze direction of the user acquired by the subject distance measurement unit 207 is a medium distance (e.g., 10 cm or more and less than 10 m), a long distance (e.g., 10 m or more), or a short distance (e.g., less than 10 cm).

When the distance to the subject in the gaze direction of the user is the medium distance, then in step ST12, the information processing device 200 sets, by the image capturing unit switching control unit 208, the normal image capturing unit 202 to be used as the magnified image capturing unit. When the distance to the subject in the gaze direction of the user is the long distance, then in step ST13, the information processing device 200 sets, by the image capturing unit switching control unit 208, the telephoto image capturing unit 203 to be used as the magnified image capturing unit. When the distance to the subject in the gaze direction of the user is the short distance, then in step ST14, the information processing device 200 sets, by the image capturing unit switching control unit 208, the close-up image capturing unit 204 to be used as the magnified image capturing unit.

After the processing of steps ST12, ST13, and ST14, the information processing device 200 determines in step ST15 whether the user has performed an operation to end the video see-through mode. When the user has not performed an operation to end the video see-through mode, the information processing device 200 returns to the processing of step ST6 to repeat the same processing as described above.

On the other hand, when the user has performed an operation to end the video see-through mode, then in step ST16, the information processing device 200 ends the operations of the image capturing units (the wide-angle image capturing unit 201, the normal image capturing unit 202, the telephoto image capturing unit 203, and the close-up image capturing unit 204), and then returns to the processing of step ST2.

In the information processing device 200 illustrated in FIG. 9, it is possible to achieve both a high-resolution real space image and reduced system load without capturing an image capturing unit input (camera input) at 4K resolution.

In the information processing device 200 illustrated in FIG. 9, the movement of the imaging direction of the magnified image capturing unit (the normal image capturing unit 202, the telephoto image capturing unit 203, the close-up image capturing unit 204) is controlled to match the user's gaze, and the movement of the focal region (high-resolution region) within the 4K resolution display image is also controlled, allowing the user to always view the real-space image in the gaze direction in high resolution.

In the information processing device 200 illustrated in FIG. 9, the image capturing unit to be used as the magnified image capturing unit can be dynamically switched to the normal image capturing unit 202, the telephoto image capturing unit 203, or the close-up image capturing unit 204 according to the distance to the subject in the gaze direction of the user, allowing the user to always view the real space image in the gaze direction in an appropriate state, for example, in a more focused state.

As described above, the information processing device 200 illustrated in FIG. 9 corresponds to the display system 10E illustrated in (a) of FIG. 7. Although detailed description will be omitted, it goes without saying that information processing devices corresponding to the display systems 10A to 10D illustrated in FIGS. 3 to 6 can be configured in a similar manner.

### 2. Modification Example

Although preferred embodiments of the present disclosure have been described in detail with reference to the accompanying drawings, the technical scope of the present disclosure is not limited to these examples. It should be apparent to those skilled in the art in the technical fields of the present disclosure that various examples of changes or modifications can be made within the scope of the technical spirit described in the claims and are, of course, to be construed as falling within the technical scope of the present disclosure.

Further, the effects described herein are merely explanatory or exemplary and are not intended as limiting. Thus, the technology according to the present disclosure may exhibit other effects apparent to those skilled in the art from the description herein, in addition to or in place of the above effects.

The present technology can be configured as follows.
(1) An information processing device including:
   an image acquisition unit that acquires a first image captured at a first angle of view and a second image captured at a second angle of view narrower than the first angle of view within the first angle of view; and
   an image generation unit that generates a display image by synthesizing an image of a high-resolution region based on the second image and an image of a peripheral region around the high-resolution region based on the first image.
(2) The information processing device according to (1), wherein
   the image of the high-resolution region is an image directly used as the second image, and
   the image of the peripheral region is an image obtained by upscaling the first image.
(3) The information processing device according to (2), wherein
   the first image and the second image each have a first resolution, and
   the image of the peripheral region is an image with a second resolution, obtained by upscaling the first image according to a ratio between the first angle of view and the second angle of view.
(4) The information processing device according to (3), wherein
   the first resolution is 1K resolution, and
   the second resolution is 4K resolution.
(5) The information processing device according to any one of (1) to (4), further including a control unit that, based on gaze information of a user, controls movement of an imaging direction of an image capturing unit for obtaining the second image and controls movement of a position of the high-resolution region.
(6) The information processing device according to (5), further including a gaze detection unit that detects the gaze information of the user.
(7) The information processing device according to any one of (1) to (6), further including a control unit that controls switching of an image capturing unit for obtaining the second image based on information on a distance to a subject related to the second image.
(8) The information processing device according to (7), further including a subject distance measurement unit for obtaining the information on the distance to the subject related to the second image.
(9) The information processing device according to (7) or (8), wherein the control unit switches the image capturing unit for obtaining the second image to either a first image capturing unit for a first imaging distance or a second image capturing unit for an imaging distance longer or shorter than the first imaging distance.
(10) The information processing device according to (9), wherein
   the first image capturing unit is a normal image capturing unit, and
   the second image capturing unit is a telephoto image capturing unit or a close-up image capturing unit.
(11) The information processing device according to (7) or (8), wherein the control unit switches the image capturing unit for obtaining the second image to any one of a first image capturing unit for a first imaging distance, a second image capturing unit for an imaging distance longer than the first imaging distance, and a third image capturing unit for an imaging distance shorter than the first imaging distance.
(12) The information processing device according to (11), wherein
   the first image capturing unit is a normal image capturing unit,
   the second image capturing unit is a telephoto image capturing unit, and
   the third image capturing unit is a close-up image capturing unit.
(13) The information processing device according to any one of (1) to (12), further including:
   a wide-angle image capturing unit for obtaining the first image; and
   a magnified image capturing unit for obtaining the second image.
(14) The information processing device according to any one of (1) to (13), further including a display unit that displays the display image.
(15) An information processing method including the steps of:
   acquiring a first image captured at a first angle of view and a second image captured at a second angle of view narrower than the first angle of view within the first angle of view; and
   generating a display image by synthesizing an image of a high-resolution region based on the second image and an image of a peripheral region around the high-resolution region based on the first image.
(16) A program for causing a computer to execute an information processing method including the steps of:
   acquiring a first image captured at a first angle of view and a second image captured at a second angle of view narrower than the first angle of view within the first angle of view; and
   generating a display image by synthesizing an image of a high-resolution region based on the second image and an image of a peripheral region around the high-resolution region based on the first image.

### Reference Signs List

10A to 10E Display system
101 Wide-angle camera
102 Normal camera
103 GPU
104 Display
105 Eye tracking system
106 Telephoto camera
107 Subject distance measurement system
108 Close-up camera (macro camera)
200 Information processing device
201 Wide-angle image capturing unit
202 Normal image capturing unit
203 Telephoto image capturing unit
204 Close-up image capturing unit
205 Image synthesis unit
206 Display unit
207 Subject distance measurement unit
208 Image capturing unit switching control unit
209 Gaze detection unit
210 Imaging direction/image synthesis control unit

1. An information processing device comprising:
an image acquisition unit that acquires a first image captured at a first angle of view and a second image captured at a second angle of view narrower than the first angle of view within the first angle of view; and
an image generation unit that generates a display image by synthesizing an image of a high-resolution region based on the second image and an image of a peripheral region around the high-resolution region based on the first image.

2. The information processing device according to claim 1, wherein
the image of the high-resolution region is an image directly used as the second image, and
the image of the peripheral region is an image obtained by upscaling the first image.

3. The information processing device according to claim 2, wherein
the first image and the second image each have a first resolution, and
the image of the peripheral region is an image with a second resolution, obtained by upscaling the first image according to a ratio between the first angle of view and the second angle of view.

4. The information processing device according to claim 3, wherein
the first resolution is 1K resolution, and
the second resolution is 4K resolution.

5. The information processing device according to claim 1, further comprising a control unit that, based on gaze information of a user, controls movement of an imaging direction of an image capturing unit for obtaining the second image and controls movement of a position of the high-resolution region.

6. The information processing device according to claim 5, further comprising a gaze detection unit that detects the gaze information of the user.

7. The information processing device according to claim 1, further comprising a control unit that controls switching of an image capturing unit for obtaining the second image based on information on a distance to a subject related to the second image.

8. The information processing device according to claim 7, further comprising a subject distance measurement unit for obtaining the information on the distance to the subject related to the second image.

9. The information processing device according to claim 7, wherein the control unit switches the image capturing unit for obtaining the second image to either a first image capturing unit for a first imaging distance or a second image capturing unit for an imaging distance longer or shorter than the first imaging distance.

10. The information processing device according to claim 9, wherein
the first image capturing unit is a normal image capturing unit, and
the second image capturing unit is a telephoto image capturing unit or a close-up image capturing unit.

11. The information processing device according to claim 7, wherein the control unit switches the image capturing unit for obtaining the second image to any one of a first image capturing unit for a first imaging distance, a second image capturing unit for an imaging distance longer than the first imaging distance, and a third image capturing unit for an imaging distance shorter than the first imaging distance.

12. The information processing device according to claim 11, wherein
the first image capturing unit is a normal image capturing unit,
the second image capturing unit is a telephoto image capturing unit, and
the third image capturing unit is a close-up image capturing unit.

13. The information processing device according to claim 1, further comprising:
a wide-angle image capturing unit for obtaining the first image; and
a magnified image capturing unit for obtaining the second image.

14. The information processing device according to claim 1, further comprising a display unit that displays the display image.

15. An information processing method comprising the steps of:
acquiring a first image captured at a first angle of view and a second image captured at a second angle of view narrower than the first angle of view within the first angle of view; and
generating a display image by synthesizing an image of a high-resolution region based on the second image and an image of a peripheral region around the high-resolution region based on the first image.

16. A program for causing a computer to execute an information processing method comprising the steps of:
acquiring a first image captured at a first angle of view and a second image captured at a second angle of view narrower than the first angle of view within the first angle of view; and
generating a display image by synthesizing an image of a high-resolution region based on the second image and an image of a peripheral region around the high-resolution region based on the first image.
